(19) United States
(12) Patent Application Publication
(10) Pub. No.: US 2011/0120392 A1
(43) Pub. Date: May 26, 2011

(54) Animal collar

(76) Inventor: Gerald Wood Smith, Columbia, SC (US)

(21) Appl. No.: 12/592,301

(22) Filed: Nov. 23, 2009

(51) Int. Cl. A01K 27/00; A01K 29/00

(52) U.S. Cl. 119/860; 119/856

(57) ABSTRACT

A novel animal collar includes an outer sleeve, and an inner band of absorbent material positioned within the outer sleeve that may be used to receive and temporarily retain liquids, and then diffuse vapor from that liquid, for various purposes. A series of holes are defined on an outer surface of the outer sleeve, positioned on the side of the collar that faces away from the animal's skin, in order to provide access for a user to apply liquid droplets through the holes directly to the absorbent layer. This collar may be used in conjunction with such substances as perfumes or colognes, insect repellants (including flea and tick treatments), germicides, and the like.

### BACKGROUND OF THE INVENTION

The present invention relates generally to novel animal collars. More specifically, the present invention relates to a novel animal collar having an outer sleeve, and an inner band of absorbent material positioned within the outer sleeve that may be used to receive and temporarily retain liquids, and then diffuse vapor from that liquid, for various purposes. This collar may be used in conjunction with such substances as perfumes or colognes, insect repellants (including flea and tick treatments), germicides, and the like.

Heretofore, many different types of pet collars have been commercialized and marketed wherein the collars have means for storing insect repellants and/or deodorants, and slowly releasing the vaporized substances. For instance, U.S. Pat. No. 6,101,981, issued to Friend, et al., discloses a pet collar having a cavity with an access opening to permit placement of a scent/deodorant element therein, so that the scented element is inserted into the cavity, and may be pulled out and replaced as necessary. U.S. Pat. No. 4,208,986 discloses an elongated housing that may be attached to a pet collar, wherein the housing serves as a receptacle for containing animal deodorizing chemicals in various forms including aromatic evaporable strips or cakes saturated with slow evaporating liquid or jelly form chemical deodorizing materials. U.S. Pat. No. 4,091,766, issued to Colliard, includes a pet collar having an absorbent strip adhered to the outer surface of the collar in contact with the neck of the animal. U.S. Pat. No. 4,068,624, issued to Ramney, discloses an animal collar having a series of small, pre-formed compartments for securing therein tablets of vaporizable active substances, such as insecticides, deodorants, pesticides, germicides and the like. The collar is designed so that the vapors therefrom are directed away from the fur of the animal.

However, none of the prior art discloses an animal collar comprising an outer sleeve disposed about an inner absorbent material, wherein the outer sleeve includes a series of holes and grommets allowing the impregnated liquid substance to evaporate and pass therethrough, and additionally allowing a user to replenish the desired liquid substance through the grommets and back into the inner layer of absorbent material as necessary.

### BRIEF SUMMARY OF THE INVENTION

In accordance with one aspect of the invention, a novel animal collar is provided. The collar comprises an outer sleeve member and an absorbent inner layer disposed within a compartment in the outer sleeve member. A series of holes, preferably defined by grommets, is disposed about an outer surface of the outer sleeve member on an opposed side from the animal's neck, providing direct access to the inner compartment and the absorbent inner layer. This arrangement allows a user to apply a desired liquid substance directly through the grommets, so that the absorbent material may be re-impregnated on an on-going basis, as necessary, without the necessity of removing the absorbent material from the outer sleeve member for replacement. Additionally, because the holes are disposed on an outer portion of the outer sleeve member, away from the animal's neck, the liquid substance and vapor does not come into direct contact with the animal's skin, thereby preventing irritation, rashes, or other problems that may occur if such a liquid or vapor were to come into direct contact with the animal's fur or skin.

The liquid substance may include perfumes, colognes, insect repellants, germicides, insecticides, or any other desirable substance. As with other types of collars, adjustable attachment means are provided, such as a buckle with corresponding holes, hook and loop fasteners, attachment clips, or any other desired means of attachment.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of the novel animal collar, showing the grommets and a liquid dropper applying drops through the grommet and into direct contact with the absorbent material therein;

FIG. 2 is a top view of one embodiment of the novel animal collar;

FIG. 2-A is a cross-sectional view along the lines 2-2 of the embodiment illustrated in FIG. 2;

FIG. 3 is a top view of another embodiment of the novel animal collar;

FIG. 3-A is a cross-sectional view along the lines 3-3 of an embodiment shown in FIG. 3;

FIG. 3-B is a cross-sectional view along the lines 3-3 of a second embodiment shown in FIG. 3;

FIG. 4 is a top view of another embodiment of the novel animal collar;

FIG. 4-A is a cross-sectional view along the lines 4-4 of an embodiment shown in FIG. 4.

### DETAILED DESCRIPTION OF THE INVENTION

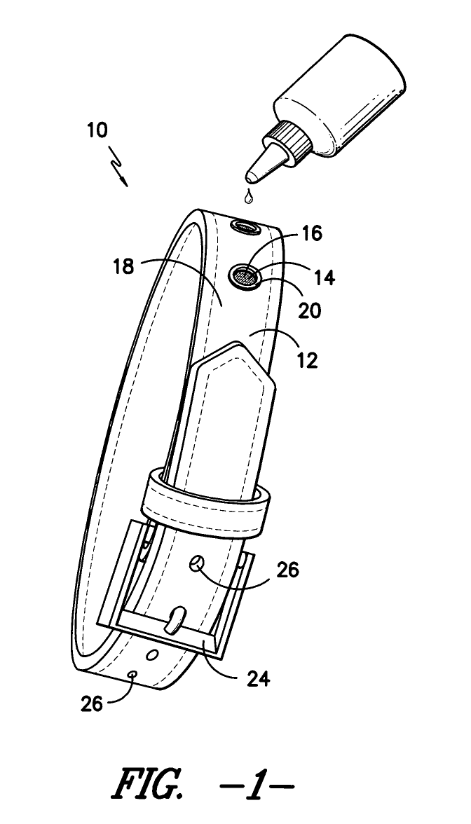

A first embodiment of a novel animal collar is shown in FIG. 1. The collar 10 includes an outer sleeve 12 having an inner compartment 22 and an inner layer 14 comprising an absorbent material. A series of holes 16 are defined on an outer surface 18 of the outer sleeve 12, positioned on the side of the collar 10 that faces away from the animal's skin. These holes 16 are preferably defined by metal or plastic grommets 20, and provide direct access to the inner compartment 22 and the inner layer of absorbent material 14. The collar 10 is shown with attachment means including a buckle 24 and a series of smaller holes 26 that engage with the buckle 24. It should be understood that other adjustable attachment means may be used to fasten one end of the collar 10 to the other when the collar 10 is placed around an animal's neck, including hook and loop fasteners, clips, snaps, or any other desired means.

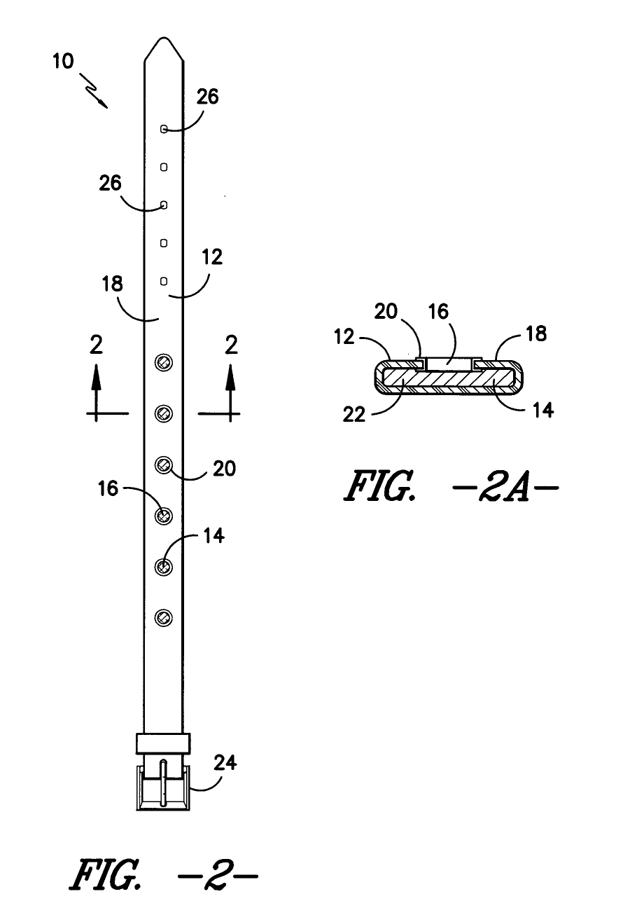

FIG. 2 shows one embodiment of the novel animal collar 10, wherein the outer sleeve 12 comprises a sleeve of singular construction that is formed around the inner absorbent layer 14. FIG. 2-A illustrates that the outer sleeve 12 is of unitary construction, and includes a grommet 20 on an outer surface 18 thereof, providing direct access to the inner absorbent layer 14 of material.

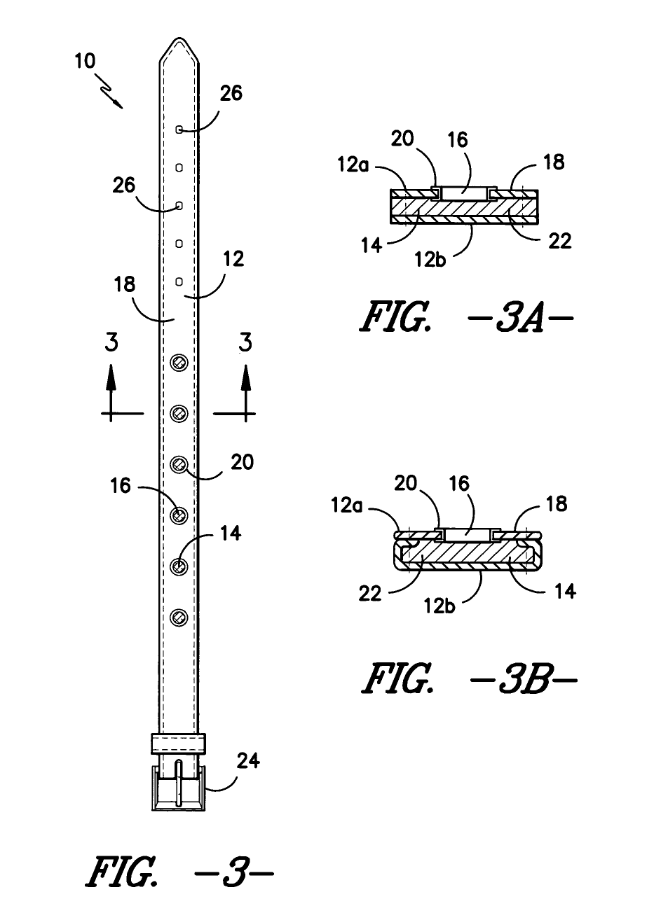

FIG. 3 shows another embodiment of the novel animal collar 10, wherein the outer sleeve 12 is formed from two separate strips 12a and 12b of material. In one embodiment, shown in FIG. 3-A, the absorbent inner layer 14 is sandwiched between two strips of material 12a and 12b, which form the outer sleeve 12, and is sewn along each side in a longitudinal direction. In another embodiment, shown in FIG. 3-B, the lower strip of material 12b is folded around the sides of the inner absorbent layer 14, and then an upper strip of material 12a is disposed above the inner absorbent layer 14. In this embodiment, the edges of the lower strip of material 12b are folded over the upper edge of the inner absorbent layer 14, and the upper layer of material 12a is sewn to the edges of the lower strip of material 12b along a longitudinal direction, forming the outer sleeve 12 as shown.

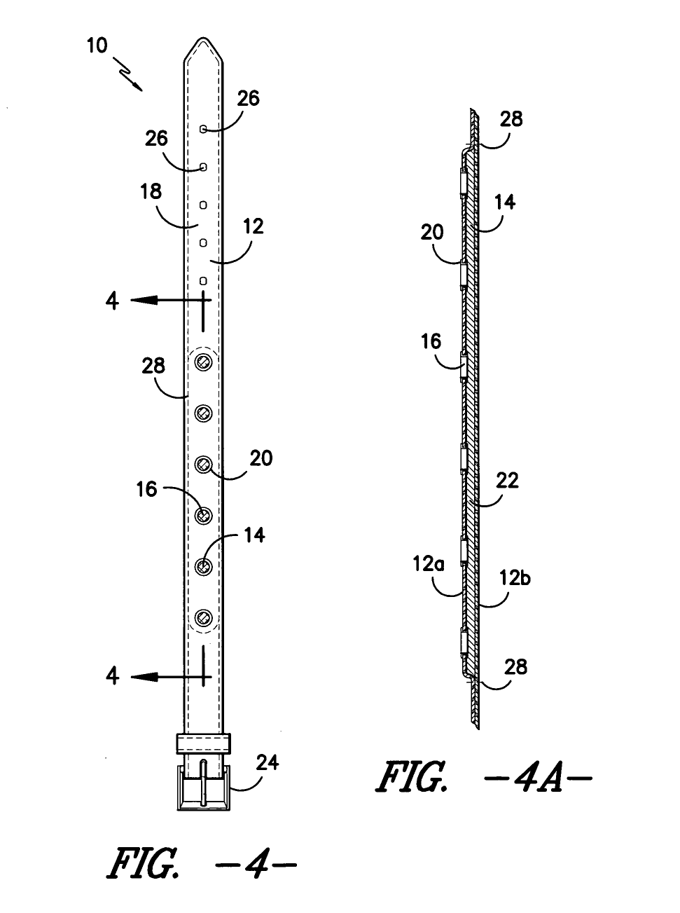

FIG. 4 shows yet another embodiment of the present invention, wherein the outer sleeve 12 comprises an upper strip 12a and lower strip 12b of material sewn together in a longitudinal direction, and wherein the upper layer 12a and lower layer 12b of the outer sleeve are sewn together to form a smaller inner compartment 22 to house the inner absorbent layer 14. FIG. 4-A shows the inner absorbent layer 14 disposed within the outer sleeve 12, wherein the stitching 28 that connects the upper layer 12a and lower layer 12b of the outer sleeve 12 is positioned around the immediate perimeter of the inner absorbent layer 14.

These arrangements allow a user to add droplets of a desired liquid substance directly to the absorbent layer 14 through the holes 16 defined in the outer sleeve 12, and further allow the liquid vapor to pass outwardly through the holes 16 as evaporation takes place. One advantage to this arrangement is that if the collar 10 is exposed to rain during foul weather, the outer sleeve 12 offers significant protection to the majority of the inner absorbent layer 14 to prevent saturation with rain water, which would dilute the liquid substance that has been retained within the inner absorbent layer 14. Further, the liquid may be applied to the inner absorbent layer 14 through the holes 16 without removing the collar 10 from the animal, if desired. Additionally, the position of the holes 16 in the outer sleeve 12 prevent the liquid from coming into direct contact with the animal's skin, and unlike much of the prior art, the absorbent strip 14 need not be replaced every time the liquid has completely evaporated.

The outer sleeve 12 may be made from any suitable material (which preferably exhibits low levels of absorbency), including leather, polymeric material or durable fabrics made from polyester or nylon, may be woven, knitted, formed into a solid material or formed in any other desired manner, as is well known in the art. It is contemplated that the inner absorbent material may also be made from any desired material, including without limitation sponge material or an absorbent fabric.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An animal collar comprising:
an outer sleeve member;
an inner layer of absorbent material disposed within an inner compartment of said outer sleeve member;
at least one hole defined on an outer portion of said outer sleeve member, wherein said hole provides direct access to said absorbent material within said inner compartment; and
adjustable attachment means for attaching said animal collar around the neck of an animal.

2. The animal collar set forth in claim 1, further comprising a plurality of said holes defined on an outer portion of said outer sleeve member, wherein said holes provide direct access to said absorbent material within said inner compartment.

3. The animal collar set forth in claim 1, wherein said adjustable attachment means is selected from the group consisting of a buckle, hook and loop fastener, snaps, and clips.

4. The animal collar set forth in claim 1, including a liquid substance applied to said inner layer of absorbent material.

5. The animal collar set forth in claim 4, wherein said liquid substance is selected from the group consisting of cologne, perfume, deodorant, insect repellant, insecticide and germicide.

6. The animal collar set forth in claim 1, further comprising a grommet disposed within said hole in said outer sleeve member.

7. The animal collar set forth in claim 2, further comprising a grommet disposed within each said hole in said outer sleeve member.
